(19) United States
(12) Patent Application Publication
(10) Pub. No.: US 2026/0135903 A1
(43) Pub. Date: May 14, 2026

(54) ARTIFICIAL INTELLIGENCE-BASED REAL-TIME DATA EXCHANGE SYSTEM IMPLEMENTING A MATCHING ENGINE FOR IDENTIFICATION OF DATA EXCHANGE PATTERNS

(71) Applicant: BANK OF AMERICA CORPORATION, Charlotte, NC (US)

(72) Inventors: Owen Nelson, Farmingdale, NY (US); Naveen Adala, Charlotte, NC (US); Kevin A. Delson, Woodland Hills, CA (US); Kirk A. Hawrysio, Oak Point, TX (US); Malinda Mae Kieffer, Chillicothe, MO (US); Anne M. Matrone, Staten Island, NY (US); Noel Arnaldo Medina, Katy, TX (US); Thomas David Morris, Middleburg, FL (US); Pankaj Nagpal, Charlotte, NC (US); Robert R. Rosseland, Huntersville, NC (US); John David Weber, Lake St. Louis, MO (US); Tanya A. Wilson, Newark, DE (US)

(73) Assignee: BANK OF AMERICA CORPORATION, Charlotte, NC (US)

(21) Appl. No.: 18/943,312

(22) Filed: Nov. 11, 2024

(51) Int. Cl. H04L 67/025

(52) U.S. Cl. CPC H04L 67/025

(57) ABSTRACT

Systems, computer program products, and methods are described herein for an Artificial Intelligence (AI)-based real-time data exchange system that implements a matching engine to identify data exchange patterns. The present disclosure is configured to receive a data exchange request, identify at least one data exchange pattern through interactions with a matching engine and data distribution networks via an application programming interface (API), and, when two or more data exchange patterns are identified, determine the selected data exchange pattern based on AI-based analysis. The system then executes the data exchange, using the interactions with the matching engine and data distribution networks through the API, employing the selected data exchange pattern. The present disclosure is further configured to implement cryptography to communicate with other systems and record results of the data exchange on a distributed ledger.

### TECHNOLOGICAL FIELD

In general, embodiments of the invention relate data exchange, and, more particularly, an artificial intelligence (AI)-based real-time data exchange system implementing a matching engine for identification of data exchange patterns.

### BACKGROUND

In today's worldwide network, the need for data exchange has become increasingly prevalent. Whether traveling abroad for conducting operations or recreations, or making consumer distribution from international distributions, individuals frequently encounter situations where disbursements must be made in a different data type. For individuals, traditional methods of data exchange are typically facilitated by institutions, often resulting in cumbersome processes, such as confined options for the data exchange, slow updates on data values, high assessments, and complex procedures, creating friction for managing operations. There is a growing need for individuals to enhance the value of their data through data distribution networks, rather than relying on traditional methods of data exchange.

Applicants have identified a number of deficiencies and problems associated with data exchange systems. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for AI-based data exchange system implementing the matching engine for identification of data exchange patterns.

In one aspect, a system for AI-based real-time data exchange implementing a matching engine at data distribution networks is provided. In some embodiments, the system includes a memory device with computer-readable program code stored thereon and at least one processing device operatively coupled to at least one memory device. Executing the computer-readable code is configured to cause the at least one processing device to receive a data exchange request. The data exchange request is (i) configured to request a data exchange from a base data type to an end data type, and (ii) includes a quantity of at least one of the base data type and the end data type. Executing the computer-readable code is configured to further cause the at least one processing device to identify, using interactions through an application programming interface (API) with a matching engine and data distribution networks, at least one data exchange pattern. In an instance where one data exchange pattern is identified, the one data exchange pattern is (i) based on a direct data exchange between the base data type and the end data type and (ii) defined as a selected data exchange pattern. Alternatively, in an instance where two or more data exchange patterns are identified, executing the computer-readable code is further configured to cause the processing device(s) to determine the selected data exchange pattern from amongst the two or more data exchange patterns based on an AI-based analysis. Further execution of the computer-readable code causes the processing device(s) to execute the data exchange, utilizing the interactions through the API with the matching engine and the data distribution networks, using the selected data exchange pattern to exchange the data from the base data type to the end data type.

In some embodiments, the data exchange pattern is based on (i) real-time data exchange rates and (ii) assessments associated with one or more data exchange.

In some embodiments, executing the computer-readable code is configured to further cause the at least one processing device to aggregate a plurality of data exchange requests, and match a first quantity of the aggregated plurality of data exchange requests to a second quantity of a counterpart data exchange requests within the data distribution networks.

In some embodiments, the base data type and the end data type are a same data type.

In some embodiments, identifying the data exchange pattern and executing the selected data exchange pattern are based on real-time data exchange rates and real-time counterpart data exchange requests at the data distribution networks.

In some embodiments, executing the computer-readable code is further configured to cause the at least one processing device to generate, using interactions through the API with the matching engine and the data distribution networks, a data exchange pattern list comprising one or more data exchange patterns. In an instance in which the data exchange pattern list includes one data exchange pattern, the data exchange pattern is based on the direct data exchange between the base data type and the end data type. Alternatively, in an instance where the data exchange pattern list comprises two or more data exchange patterns, the two or more data exchange patterns are determined by the AI-based analysis. Moreover, executing the computer-readable code is further configured to cause the at least one processing device to receive, via a user device, the selected data exchange pattern from a user by transmitting the data exchange pattern list to the user with a request of selecting the selected data exchange pattern. In related embodiments, the one or more data exchange patterns in the data exchange list are based on (i) real-time data exchange rates and (ii) assessments associated with one or more data exchanges.

In some embodiments, executing the computer-readable code is configured to cause the at least one processing device to store data exchange information associated with the data exchange request on a distributed ledger. In some embodiments, executing the computer-readable code is further configured to cause the at least one processing device to generate at least one of encrypted internal digital information and external digital information. In an instance where internal digital information is transmitted outbound, executing the computer-readable code is configured to cause the at least one processing device to generate the encrypted internal digital information by encrypting the internal digital information. Alternatively, in an instance where encrypted external digital information is received inbound, executing the computer-readable code is configured to cause the at least one processing device to generate the external digital information by decrypting the encrypted external digital information.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for AI-based data exchange system implementing a matching engine, in accordance with an embodiment of the disclosure;

FIG. 2 illustrates an exemplary machine learning (ML) subsystem architecture, in accordance with an embodiment of the invention.

FIGS. 3A-3B illustrate an exemplary distributed ledger technology (DLT) architecture, in accordance with an embodiment of the invention.

FIG. 4 illustrates a process flow for a real-time data exchange system (DES), in accordance with an embodiment of the disclosure.

FIG. 5 illustrates a process flow for aggregating a plurality of data exchange requests, in accordance with an embodiment of the disclosure.

FIG. 6 illustrates a process flow for selecting the data exchange pattern based on the user's decision, in accordance with an embodiment of the disclosure.

FIG. 7 illustrates a process flow for storing the results of the data exchange process, in accordance with an embodiment of the disclosure.

FIG. 8 illustrates a process flow for securing the DES using cryptography, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” or a “user device” may be a point of human-computer interaction and communication in a device that allows a user to input information, such as commands or data, into a device, or that allows the device to output information to the user. For example, the user interface or the user device includes a graphical user interface (GUI) or an interface to input computer-executable instructions that direct a processor to carry out specific functions. The user interface or the user device typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer,” a “transaction,” a “transaction event” or a “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points a. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

As used herein, “data” may refer to digital currency stored on computer devices, existing in electronic form. The data functions similarly to physical currency, as it can be stored, transferred, exchanged, and used for various transactions within the virtual realm. In some embodiments, the term “data” may specifically refer to currency. The term “data exchange” may refer to currency exchange or currency trading, the term “data exchange rate” may refer to a currency exchange rate, the term “base data type” may refer to a base currency, the term “quote data type” may refer to a quote currency, and the term “end data type” may refer to a final quote currency that is converted from the base currency through chains of currency exchanges. Just as currency exchange involves exchanging the base currency for the quote currency using the exchange rate between the currency pair, data exchange involves exchanging the base data type for the quote data type using the exchange rate between the data type pair.

As used herein, “data distribution network” may refer to foreign exchange market (e.g., Forex market or FX market) where data type pair is exchanged. The participants may connect to the data distribution network to receive real-time information associated with the data exchange and participate executing the data exchange process. In some embodiments, the data distribution networks may be configured to provide and maintain technology infrastructures for fast and secure connection to the participants'systems. Further, data distribution networks may comprise peril management systems that provide peril analysis data to the participants'systems.

In the field of data exchange, economic activities of individuals, such as retail transactions involving data exchange and demands of data exchange for individual's need are typically not considered part of the exchange in the data distribution network due to relatively small size of retail transactions and large number of requests for data exchange. When exchanging data, individuals have limited options among data exchange networks'participants to facilitate the exchange. As a result, individuals often face high assessments, slow updates on data exchange rates, and limited access to information.

Recent improvements in network infrastructure have enabled large data flows, while enhancements in algorithms used in matching engines have made it possible to execute data exchanges instantly, allowing for the management of a large number of data exchange requests from individuals. By implementing AI-based decision-making process and utilizing real-time information from the data distribution networks, data distribution network participants may facilitate secure and efficient data exchanges for individuals.

Accordingly, the present disclosure describes a data exchange system (DES) that implements a matching engine to identify data exchange patterns (e.g., currency arbitrage), allowing users to take advantage of real-time information associated with the currency exchange from the data distribution networks. The system may be configured to implement an AI-based decision-making process that monitors economic data, market sentiment, political stability, and/or any other factors influencing the data distribution networks. Additionally, the system may aggregate data exchange requests to match the size of counter data exchange requests, execute the exchange process, and store the execution results on a distributed ledger.

What is more, the present disclosure provides a technical solution to a technical problem. As described herein, the technical problem includes exclusion of the data exchange request associated with the users at the data distribution networks. The technical solution presented herein allows for users to participate in the time-variant environment of the data distribution networks. In particular, facilitating the user's data exchange request is an improvement over existing solutions to the traditional methods of the data exchange where users have limited access to the data exchange information and high assessments to the mediating participants, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, and (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

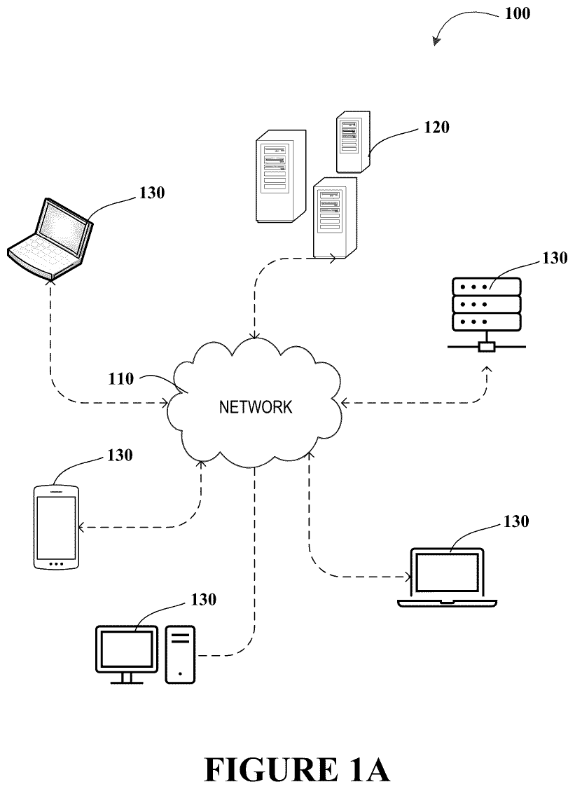

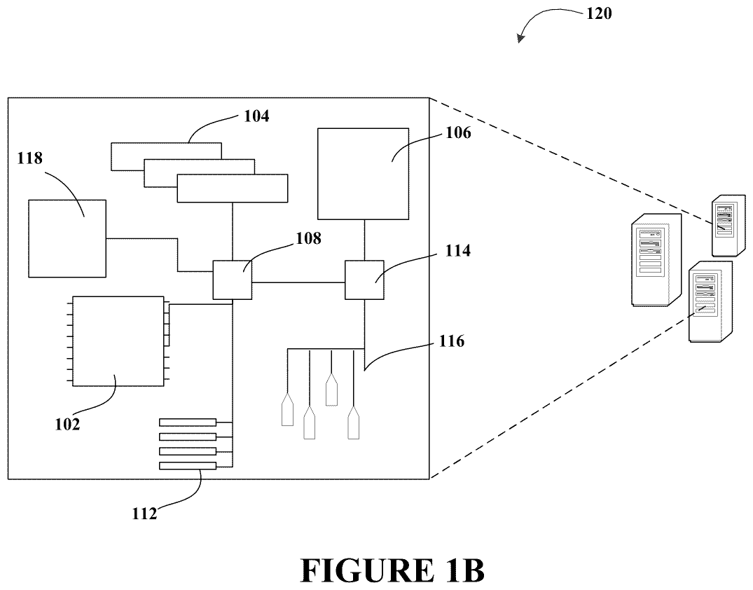

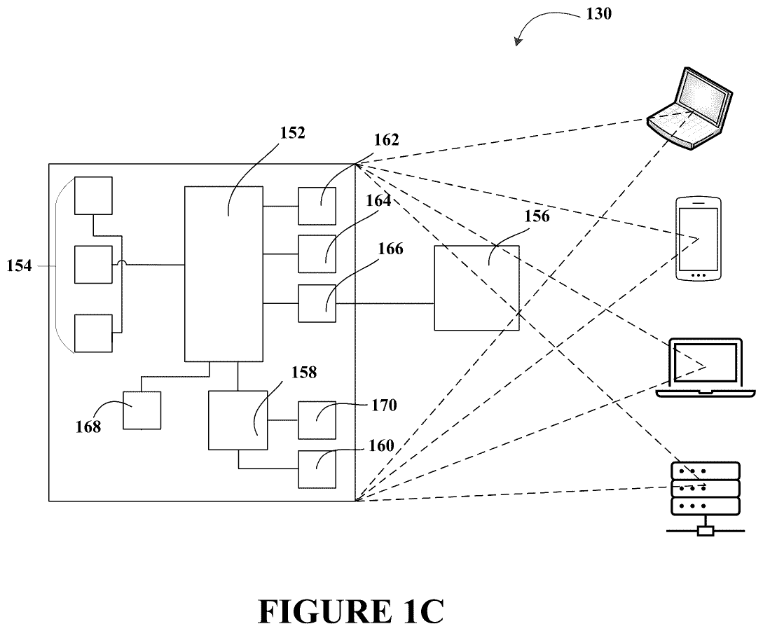

FIGS. 1A-1C illustrate technical components of an exemplary distributed computing environment for AI-based real-time data exchange system 100, in accordance with an embodiment of the disclosure. As shown in FIG. 1A, the distributed computing environment 100 contemplated herein may include a system 120, an end-point device(s) 130, and a network 110 over which the system 120 and end-point device(s) 130 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 120, with each system providing portions of the necessary operations (e.g., as a server bank, a group of blade servers, or a multi-processor system).

In some embodiments, the system 120 and the end-point device(s) 130 may have a client-server relationship in which the end-point device(s) 130 are remote devices that request and receive service from a centralized server, i.e., the system 120. In some other embodiments, the system 120 and the end-point device(s) 130 may have a peer-to-peer relationship in which the system 120 and the end-point device(s) 130 are considered equal and all have the same abilities to use the resources available on the network 110. Instead of having a central server (e.g., system 120) which would act as the shared drive, each device that is connect to the network 110 would act as the server for the files stored on it.

The system 120 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 130 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 120 may be separated into two or more distinct portions.

FIG. 1B illustrates an exemplary component-level structure of the system 120, in accordance with an embodiment of the disclosure. As shown in FIG. 1B, the system 120 may include a processor 102, memory 104, a storage device 106 and an input/output (I/O) device 118. The system 120 may also include a high-speed interface 108 connecting to the memory 104, and a low-speed interface 114 connecting to low-speed bus 116 and storage device 106. Each of the components 102, 104, 106, 108, 110, 114, and 116 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 120) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 120 using any subsystems described herein. It is to be understood that the system 120 may use, as appropriate, multiple processors, along with multiple memories, and/or I/O devices, to execute the processes described herein.

The memory 104 stores information within the system 120. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 120 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 106, or memory on processor 102.

The high-speed interface 108 manages bandwidth-intensive operations for the system 120, while the low-speed interface/controller 114 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 112, which may accept various expansion cards (not shown). In such an implementation, low-speed interface/controller 114 is coupled to storage device 106 and low-speed bus/expansion port 116. The low-speed bus/expansion port 116, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 120 may be implemented in a number of different forms. For example, the system 1320 may be implemented as a standard server, or multiple times in a group of such servers. Additionally, the system 120 may also be implemented as part of a rack server system or a personal computer such as a laptop computer. Alternatively, components from system 120 may be combined with one or more other same or similar systems and an entire system 120 may be made up of multiple computing devices communicating with each other.

FIG. 1C illustrates an exemplary component-level structure of the end-point device(s) 130, in accordance with an embodiment of the disclosure. As shown in FIG. 1C, the end-point device(s) 130 includes a processor 152, memory 154, an input/output device such as a display 156, a communication interface 158, and a transceiver 160, among other components. The end-point device(s) 130 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 130, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 130, such as control of user interfaces, applications run by end-point device(s) 130, and wireless communication by end-point device(s) 130.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 130 with other devices. External interface 168 may provide, for example, for wired communication in some implementations, or for wireless communication in other implementations, and multiple interfaces may also be used.

The memory 154 stores information within the end-point device(s) 130. The memory 154 can be implemented as one or more of a computer-readable medium or media, a volatile memory unit or units, or a non-volatile memory unit or units. Expansion memory may also be provided and connected to end-point device(s) 130 through an expansion interface (not shown), which may include, for example, a SIMM (Single In Line Memory Module) card interface. Such expansion memory may provide extra storage space for end-point device(s) 130 or may also store applications or other information therein. In some embodiments, expansion memory may include instructions to carry out or supplement the processes described above and may include secure information also. For example, expansion memory may be provided as a security module for end-point device(s) 130 and may be programmed with instructions that permit secure use of end-point device(s) 130. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 130 to transmit and/or receive information or commands to and from the system 120 via the network 110. Any communication between the system 120 and the end-point device(s) 130 may be subject to an authentication protocol allowing the system 120 to maintain security by permitting only authenticated users (or processes) to access the protected resources of the system 120, which may include servers, databases, applications, and/or any of the components described herein. To this end, the system 120 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 130 may provide the system 120 (or other client devices) permissioned access to the protected resources of the end-point device(s) 130, which may include a GPS device, an image capturing component (e.g., camera), a microphone, and/or a speaker.

The end-point device(s) 130 may communicate with the system 120 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing, and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 130, which may be used as appropriate by applications running thereon, and in some embodiments, one or more applications operating on the system 120.

The end-point device(s) 130 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 130. Such sound may include sound from voice telephone calls, may include recorded sound (e.g., voice messages, music files, or the like) and may also include sound generated by one or more applications operating on the end-point device(s) 130, and in some embodiments, one or more applications operating on the system 120.

Various implementations of the distributed computing environment 100, including the system 120 and end-point device(s) 130, and techniques described here can be realized in digital electronic circuitry, integrated circuitry, specially designed ASICs (application specific integrated circuits), computer hardware, firmware, software, and/or combinations thereof.

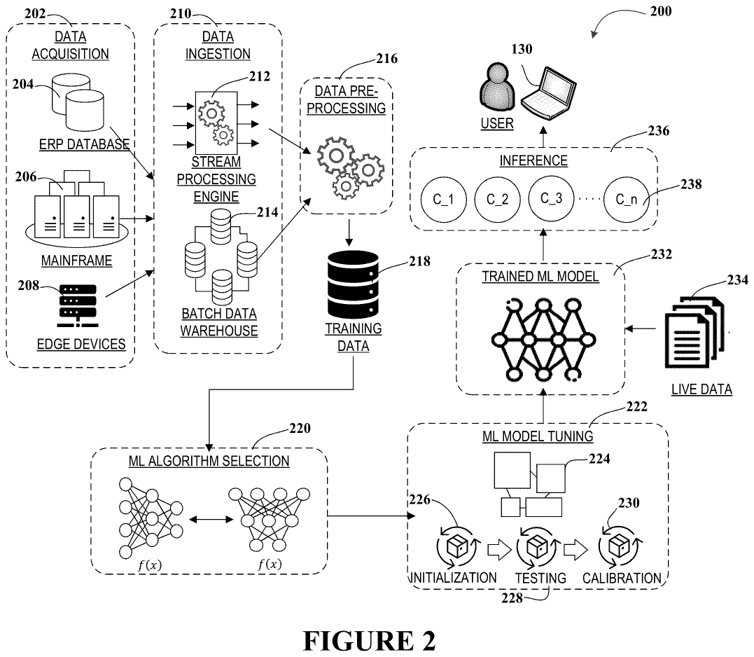

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and /r combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 140. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

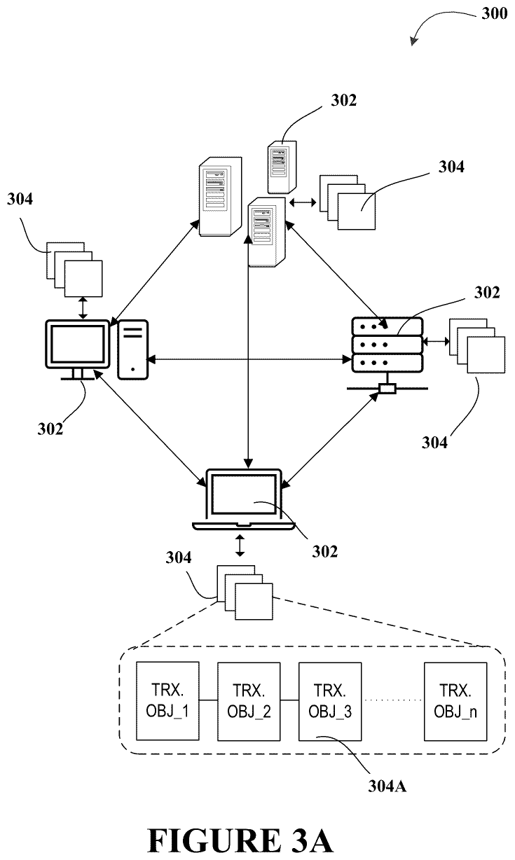

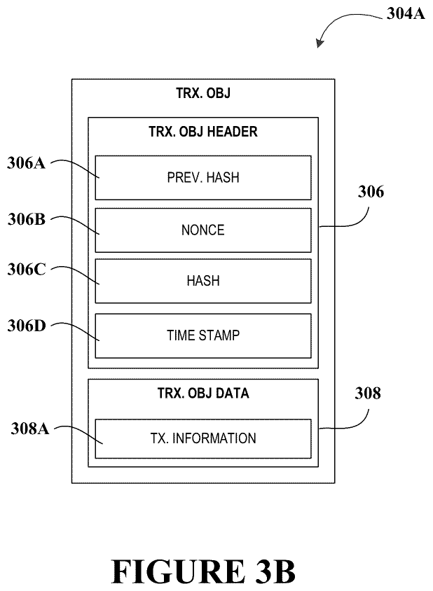

FIGS. 3A-3B illustrate an exemplary distributed ledger technology (DLT) architecture, in accordance with an embodiment of the invention. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general-purpose deployment of decentralized applications. In some embodiments, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 3A, the exemplary DLT architecture 300 includes a distributed ledger 304 being maintained on multiple devices (nodes) 302 that are authorized to keep track of the distributed ledger 304. For example, these nodes 302 may be computing devices such as system 130 and client device(s) 140. One node 302 in the DLT architecture 300 may have a complete or partial copy of the entire distributed ledger 304 or set of transactions and/or transaction objects 304A on the distributed ledger 304. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 3B, an exemplary transaction object 304A may include a transaction header 306 and a transaction object data 308. The transaction header 306 may include a cryptographic hash of the previous transaction object 306A, a nonce 306B—a randomly generated 32-bit whole number when the transaction object is created, cryptographic hash of the current transaction object 306C wedded to the nonce 306B, and a time stamp 306D. The transaction object data 308 may include transaction information 308A being recorded. Once the transaction object 304A is generated, the transaction information 308A is considered signed and forever tied to its nonce 306B and hash 306C. Once generated, the transaction object 304A is then deployed on the distributed ledger 304. At this time, a distributed ledger address is generated for the transaction object 304A, i.e., an indication of where it is located on the distributed ledger 304 and captured for recording purposes. Once deployed, the transaction information 308A is considered recorded in the distributed ledger 304.

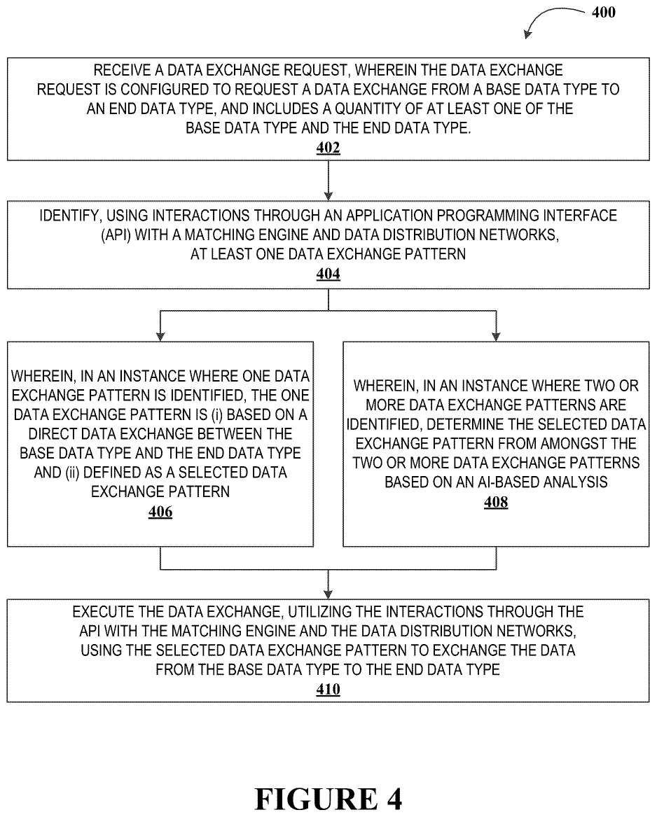

FIG. 4 illustrates a process flow 400 for a real-time data exchange system (DES), in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 120 described herein with respect to FIG. 1A-1C) may perform the steps of process 400.

As shown at Event 402, a data exchange request (e.g., currency exchange request) is received. The data exchange request is configured to request a data exchange (e.g., currency exchange) from a base data type (e.g., first currency type), to an end data type (second currency type). The data exchange request includes a quantity (e.g., amount) of at least one of the base data type and the end data type. For example, the Data Exchange System (DES) may be configured to receive the data exchange request, identify a selected data exchange pattern, and execute the resource transfer based on the selected data exchange pattern.

In some embodiments, the DES may be configured to receive a data exchange request associated with the user through interaction with the end-point device(s) 140. This request may originate directly from a user via a user device, a payment instrument associated with the user's resource transfer, a point-of-sale (POS) device and/or the like. In such embodiments, the data exchange request may comprise information such as the base data type, a quantity of the base data type, an end data type, a quantity of the end data type, and/or any other information associated with the data exchange process. For example, and in some embodiments, the data exchange request may request identifying the quantity of the end data type by providing the base data type, the quantity of the base data type, and the required end data type. Alternately, and in some embodiments, the data exchange request may request identifying the quantity of the base data type by providing the end data type, the quantity of the end data type, and the corresponding base data type.

At Event 404, at least one data exchange pattern is identified using interactions through an application programming interface (API) with a matching engine and the data distribution networks. At Event 406, in an instance where one data exchange pattern is identified, the one data exchange pattern is (i) based on a direct data exchange between the base data type and the end data type and (ii) defined as a selected data exchange pattern. For example, and in some embodiments, the DES may be configured to convert the data exchange request to a query and connect with the data distribution networks through the API to receive information associated with the data exchange such as real-time data exchange rates (e.g., real time currency exchange rates), the quantity of the exchange orders, and/or the like to identify at least one possible data exchange pattern.

In some embodiments, the participants in the data distribution networks may operate systems that may comprise software, algorithms, matching engines, platforms, and/or the like to automate the data exchange processes based on certain parameters or rules set by the participant. In some embodiments, the data distribution networks may provide an API Plug-in to participants'systems (e.g., the matching engine of the DES), whereby the participants'systems may access the data distribution network to utilize the features of the data distribution networks. For example, and in some embodiments, the DES may be configured to access, using the matching engine, to the data distribution network through the API Plug-in from the data distribution networks to receive real-time information associated with the data exchange to process the data exchange request.

As used herein, the term “data exchange pattern” may refer to currency arbitrage, wherein the data exchange pattern is determined by analyzing value discrepancies between data type pairs in a time-variant environment. As such, the data exchange pattern may yield a greater quantity of the end data type from a given quantity of the base data type, or it may require less of the base data type to obtain the required quantity of the end data type, compared to a direct exchange between the base data type and the end data type.

In some embodiments, the data exchange pattern may comprise a two-point arbitrage, triangular arbitrage, multilateral arbitrage, and/or a combination of multiple currency arbitrages. Additionally, the data exchange pattern may comprise direct exchanges from the base data type to the end data type or include intermediary exchanges amongst data types other than the base data type and end data type. Further, the data exchange pattern may comprise assessments at each stage of the data exchange process.

In some embodiments, the identified currency arbitrage may produce fewer results compared to the direct data exchange, wherein the identified data exchange pattern may consist solely of the direct exchange between the base data type and the end data type. As such, the selected data exchange pattern is the direct data exchange between the base data type and the end data type.

At Event 408, in an instance where two or more data exchange patterns are identified, the selected data exchange pattern is determined from amongst the two or more data exchange patterns based on an AI-based analysis. For example, and in some embodiments, the DES may be configured to identify currency arbitrages that yield better results than a direct data exchange.

In some embodiments, the DES may be configured to receive real-time market information that may comprise information on data exchange rates, news, and/or other economic indicators, wherein the information may influence the data distribution network from real-time market feed providers. Additionally, the DES may be configured to receive peril analysis data associated with the data exchange patterns from the data distribution networks.

In such embodiments, the DES may be configured to utilize an AI-based analysis using the machine learning (ML) subsystem architecture 200 shown and previously described in relation to FIG. 2. The DES may be configured to use real-time market information as the live data 234 to the trained machine learning model 232 to predict the perils associated with the data exchange when selecting the data exchange pattern. Such a trained ML model 232 may be pre-trained by the DES using historical data on data exchange rates, economic indicators, news sentiments, peril analysis data from the data distribution network, and/or other relevant factors.

In some embodiments, the DES may be configured to calculate assessments associated with the entire data exchange process, whereby assessments may be considered along with other factors to identify data exchange patterns. Such assessments may be set by the participant systems involved in the data exchange, the data distribution network, the DES, and/or the like. The assessments may be based on a percentage of the data exchange amount, with the percentage tiered according to the size of the exchange.

Thus, and in some embodiments, the DES may be configured to determine the selected data exchange pattern based on the identified data exchange patterns, the assessments associated with the data exchange, the AI-based analysis, regulatory compliances and global standards (e.g., a ban list of country, FX global code, or the like), and/or the like.

At Event 410 the data exchange is executed using the interactions through the API with the matching engine and the data distribution networks, using the selected data exchange pattern to exchange the data from the base data type to the end data type. For example, and in some embodiments, the DES may be configured to execute, using the matching engine, the data exchange based on the selected data exchange pattern by accessing to the data distribution networks through the API plug-in from the data distribution networks.

In some embodiments, the DES may comprise the matching engine that automates data exchange process using advanced algorithms, such as order matching algorithms, liquidity-providing algorithms, execution algorithms, arbitrage algorithms, market-making algorithms, and/or the like. Such a matching engine comprises powerful computing hardware to manage large volumes of data exchange processes, parallelly and/or sequentially, at high speed. Further, the matching engine may be configured to handle high-frequency trading (HFT) and provide low-latency connections to data distribution networks, enabling fast and efficient data exchanges.

In some embodiments, the DES may be configured to interact with external systems to identify data exchange patterns and/or execute data exchange requests. The interaction with the external systems (e.g., similar DES systems operated by other institutions) may create synergies in the data exchange process, such as aggregating exchange requests to increase the volume for more efficient execution, reducing the number of intermediaries involved, backing up DES functions in case of a failure, and/or the like.

In some embodiments, the DES may be configured to identify the data exchange patterns when the base data type and the end data type are a same data type. In such embodiments, the DES may be configured to execute the data exchange process with the selected data exchange pattern, wherein the selected data exchange pattern is determined by the AI-based analysis among the two or more identified data exchange patterns.

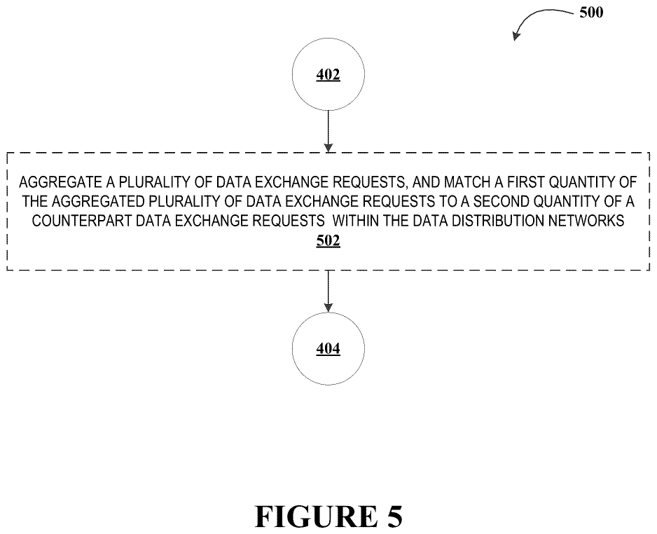

FIG. 5 illustrates a process flow 500 for aggregating the data exchange request, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 120 described herein with respect to FIG. 1A-1C) may perform the steps of process 500.

At Event 502, a plurality of data exchange requests from different users are aggregated and a first quantity of the aggregated plurality of data exchange requests is matched to a second quantity of a counterpart data exchange requests within the data distribution networks. In some embodiments, and as shown herein, the process described herein with respect to Event 502 may follow the processes described hereinabove with respect to block 402 of FIG. 4. In some embodiments, and as shown herein, the process described herein with respect to Event 502 may precede the processes described hereinabove with respect to Event 404 of FIG. 4.

In some embodiments, the DES may be configured to identify real-time counterpart data exchange requests from other participants within the data distribution networks. To execute the data exchange, the DES may need to match the quantity of the counterpart data exchange by aggregating the quantity of the data exchange request and/or available data from the DES to expedite the process. Moreover, and in some embodiments, the DES may interact with the external systems to aggregate data exchange requests and/or available data from the external systems in order to match the counterpart quantity for the data exchange. In some embodiments, the counterpart data exchange request may comprise one or more data exchange requests aggregated by the other participants.

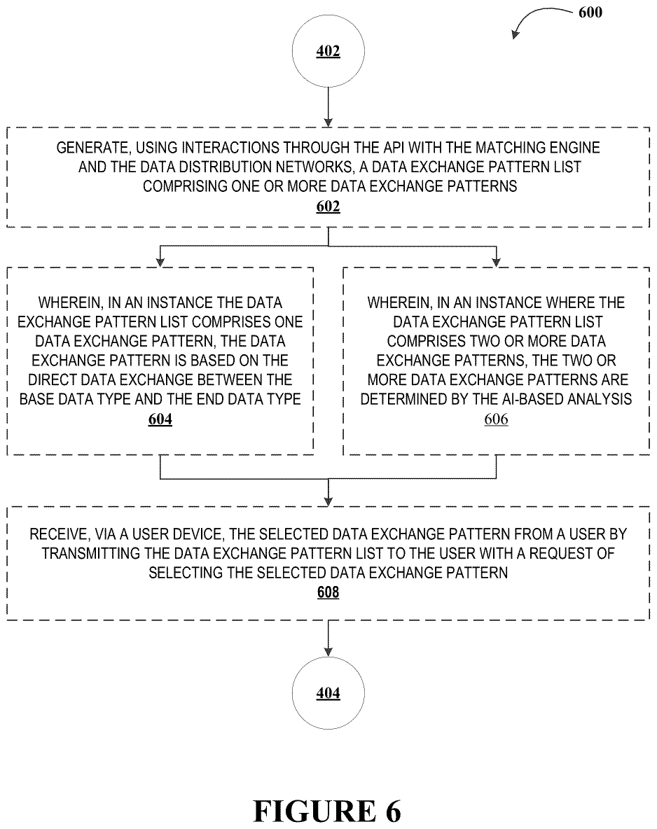

FIG. 6 illustrates a process flow 600 for selecting the data exchange pattern based on the user's decision, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 120 described herein with respect to FIG. 1A-1C) may perform the steps of process 600.

At Event 602, a data exchange pattern list is generated using interactions through the API with the matching engine and the data distribution networks. The data exchange pattern list comprising one or more data exchange patterns. At Event 604, in an instance the data exchange pattern list comprises one data exchange pattern, the data exchange pattern is based on the direct data exchange between the base data type and the end data type. In some embodiments, and as shown herein, the process described herein with respect to block 602 may follow the processes described hereinabove with respect to block 402 of FIG. 4. In some embodiments, and as shown herein, the process described herein with respect to block 608 may precede the processes described hereinabove with respect to block 404 of FIG. 4.

For example, and in some embodiments, the user may transmit a request to the DES, via the user device, for the possible data exchange patterns along with the base data type, the end data type, and the quantity of the base data type or the quantity of the end data type. Then, the DES may be configured to generate the data exchange pattern list by identifying possible data exchange patterns based on the real-time data from the data distribution network.

In some embodiments, the identified currency arbitrage may produce fewer results compared to the direct data exchange, wherein the identified data exchange pattern may consist solely of the direct exchange between the base data type and the end data type. As such, the data exchange pattern list comprises only the direct data exchange between the base data type and the end data type.

At Event 606, in an instance where the data exchange pattern list comprises two or more data exchange patterns, the two or more data exchange patterns are determined by the AI-based analysis. For example, and in some embodiments, the DES may be configured to generate the data exchange pattern list comprising the data exchange patterns that yield better results than the direct data exchange and are determined by AI-based analysis.

In some embodiments, and as described above, the DES may be configured to utilize the AI-based analysis using the ML subsystem architecture 200 shown and previously described in relation to FIG. 2. The DES may be configured to use real-time market information as the live data 234 to the trained machine learning model 232 to predict the perils associated with the data exchange when determining the data exchange pattern. Further, the DES may be configured to calculate the assessments associated with all the data exchange process, whereby assessments may be considered to identify the data exchange patterns.

At Event 608, the selected data exchange pattern from the list is received from the user, via a user device, by transmitting the data exchange pattern list to the user with a request of selecting the selected data exchange pattern. For example, and in some embodiments, the DES may be configured to transmit the data exchange list to the user, whereby the user may select the data exchange pattern based on the user's decision. Then, the DES may be configured to receive the selected data exchange pattern to execute the data exchange request.

In some embodiments, the DES may be configured to repeat steps of 602, 604, and 606 at a pre-defined time as the possible data exchange patterns may change due to the time-variant environment of the data distribution networks. Thereafter, the DES may transmit an updated data exchange pattern list to the user to select the data exchange pattern based on the updated data exchange pattern list. In some embodiments, the DES may limit duration of the selection process from the user, whereby limiting the duration may reduce the failure of executing the data exchange process due to the time-variant environment at the data distribution networks.

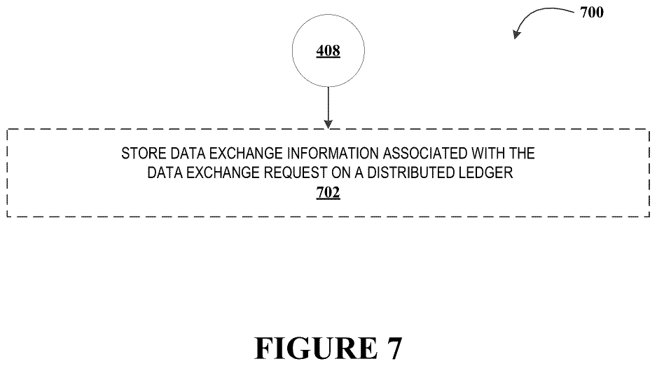

FIG. 7 illustrates a process flow 700 for storing the results of the data exchange process, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 120 described herein with respect to FIG. 1A-1C) may perform the steps of process 700.

As shown in block 702, the process flow 700 may include the step of storing data exchange information associated with the data exchange request on a distributed ledger. In some embodiments, and as shown herein, the process described herein with respect to block 702 may follow the processes described hereinabove with respect to block 408 of FIG. 4.

For example, in some embodiments, the DES may be configured to store data exchange information on the distributed ledger. The data exchange information may comprise the data exchange request, the selected data exchange pattern, the time of the exchange, the data exchange results, and other relevant details. In such embodiments, the data exchange information is recorded in the transaction object data 308 shown in FIG. 3B, followed by the deployment of transaction object 304A on the distributed ledger 304 of FIG. 3A.

In some embodiments, the DES may be configured to transmit the results of the data exchange process to the users via the user device or any other systems that transmitted the data exchange request. Such a data exchange results may comprise the base data type, the end data type, the quantities of the base data type and the end data type, the executed data exchange pattern, the data exchange rates, any quote data type and quantity of the quote data type, associated with the executed data exchange pattern, any assessments associated with the data exchange, time stamps, and/or the like. In some embodiments, the DES may be configured to transmit the past data exchange results stored in a storage (e.g., a database, the distributed ledger, and/or the like) to the user via the user device.

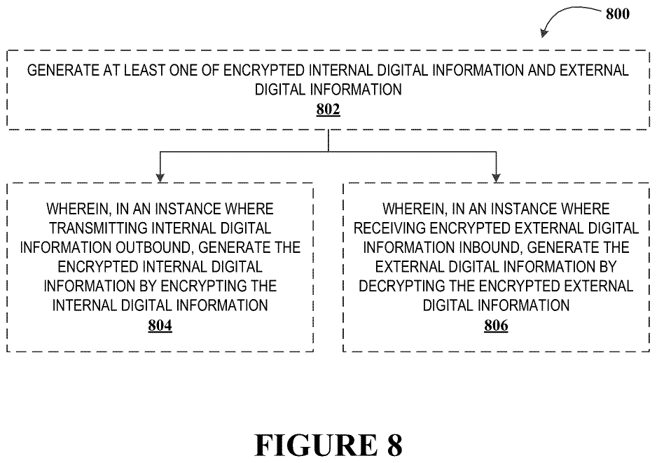

FIG. 8 illustrates a process flow 800 for securing the DES using cryptography, in accordance with an embodiment of the disclosure. In some embodiments, a system (e.g., similar to one or more of the systems described herein with respect to FIGS. 1A-1C) may perform one or more of the steps of process flow 800. For example, a system (e.g., the system 120 described herein with respect to FIG. 1A-1C) may perform the steps of process 800. For example, and in some embodiments, the DES may be configured to use cryptography when communicating with other systems.

At Event 802, at least one of encrypted internal digital information and external digital information is generated. At Event 804, in an instance where transmitting internal digital information outbound, the encrypted internal digital information is generated by encrypting the internal digital information. For example, and in some embodiments, the DES may be configured to encrypt internal information to generate encrypted internal information when transmitting the internal information outbound from the DES to other systems. Such a cryptography may comprise Transport Layer Security (TLS), Secure Sockets Layer (SSL), digital signatures, multi-factor authentication, Advanced Encryption Standard (AES), Payment Card Industry Data Security Standard (PCI DSS), and/or the like.

At Event 806, in an instance where receiving encrypted external digital information inbound, the external digital information is generated by decrypting the encrypted external digital information. For example, and in some embodiments, the DES may receive encrypted external information received from the other systems and generate the corresponding external digital information.

In some embodiments, the DES may be configured to protect its system and sub-systems (e.g., matching engine) from cyber threats and ensure the data exchange process. As such, the DES may be configured to use firewalls, multi-factor authentication, intrusion detection and prevention system (IDS/IPS), data backups, and/or the like.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for an Artificial Intelligence (AI)-based real-time data exchange, the system comprises:
a memory device with computer-readable program code stored thereon; and
at least one processing device operatively coupled to at least one memory device, wherein executing the computer-readable code is configured to cause the at least one processing device to:
receive a data exchange request, wherein the data exchange request is configured to request a data exchange from a base data type to an end data type, and includes a quantity of at least one of the base data type and the end data type,
identify, using interactions through an Application Programming Interface (API) with a matching engine and data distribution networks, at least one data exchange pattern,
wherein, in an instance where one data exchange pattern is identified, the one data exchange pattern is (i) based on a direct data exchange between the base data type and the end data type and (ii) defined as a selected data exchange pattern, or
wherein, in an instance where two or more data exchange patterns are identified, determine the selected data exchange pattern from amongst the two or more data exchange patterns based on an AI-based analysis,
execute the data exchange, utilizing the interactions through the API with the matching engine and the data distribution networks, using the selected data exchange pattern to exchange the data from the base data type to the end data type.

2. The system of claim 1, wherein the data exchange pattern is based on (i) real-time data exchange rates and (ii) assessments associated with one or more data exchange.

3. The system of claim 1, wherein executing the computer-readable code is configured to further cause the at least one processing device to:
aggregate a plurality of data exchange requests, and
match a first quantity of the aggregated plurality of data exchange requests to a second quantity of a counterpart data exchange requests within the data distribution networks.

4. The system of claim 1, wherein the base data type and the end data type are a same data type.

5. The system of claim 1, wherein identifying the data exchange pattern and executing the selected data exchange pattern are based on real-time data exchange rates and real-time counterpart data exchange requests at the data distribution networks.

6. The system of claim 1, wherein executing the computer-readable code is further configured to cause the at least one processing device to:
generate, using interactions through the API with the matching engine and the data distribution networks, a data exchange pattern list comprising one or more data exchange patterns,
wherein, in an instance the data exchange pattern list comprises one data exchange pattern, the data exchange pattern is based on the direct data exchange between the base data type and the end data type or
wherein, in an instance where the data exchange pattern list comprises two or more data exchange patterns, the two or more data exchange patterns are determined by the AI-based analysis; and
receive, via a user device, the selected data exchange pattern from a user by transmitting the data exchange pattern list to the user with a request of selecting the selected data exchange pattern.

7. The system of claim 6, wherein the one or more data exchange patterns in the data exchange list are based on (i) real-time data exchange rates and (ii) assessments associated with one or more data exchanges.

8. The system of claim 1, wherein executing the computer-readable code is configured to cause the at least one processing device to store data exchange information associated with the data exchange request on a distributed ledger.

9. The system of claim 1, wherein executing the computer-readable code is further configured to cause the at least one processing device to:
generate at least one of encrypted internal digital information and external digital information,
wherein, in an instance where transmitting internal digital information outbound, generate the encrypted internal digital information by encrypting the internal digital information, or
wherein, in an instance where receiving encrypted external digital information inbound, generate the external digital information by decrypting the encrypted external digital information.

10. A computer program product for an Artificial Intelligence (AI)-based real-time data exchange, the computer program product comprising a non-transitory computer-readable medium comprising code causing an apparatus to:
receive a data exchange request, wherein the data exchange request is configured to request a data exchange from a base data type to an end data type, and includes a quantity of at least one of the base data type and the end data type;
identify, using interactions through an Application Programming Interface (API) with a matching engine and data distribution networks, at least one data exchange pattern,
wherein, in an instance where one data exchange pattern is identified, the one data exchange pattern is (i) based on a direct data exchange between the base data type and the end data type and (ii) defined as a selected data exchange pattern, or
wherein, in an instance where two or more data exchange patterns are identified, determine the selected data exchange pattern from amongst the two or more data exchange patterns based on an AI-based analysis; and
execute the data exchange, utilizing the interactions through the API with the matching engine and the data distribution networks, using the selected data exchange pattern to exchange the data from the base data type to the end data type.

11. The computer program product of claim 10, wherein the data exchange pattern is based on (i) real-time data exchange rates and (ii) assessments associated with one or more data exchange.

12. The computer program product of claim 10, wherein the code further causes the apparatus to:
aggregate a plurality of data exchange requests, and
match a first quantity of the aggregated plurality of data exchange requests to a second quantity of a counterpart data exchange requests within the data distribution networks.

13. The computer program product of claim 10, wherein the base data type and the end data type are a same data type.

14. The computer program product of claim 10, wherein the code further causes the apparatus to:
generate, using interactions through the API with the matching engine and the data distribution networks, a data exchange pattern list comprising one or more data exchange patterns,
wherein, in an instance the data exchange pattern list comprises one data exchange pattern, the data exchange pattern is based on the direct data exchange between the base data type and the end data type or
wherein, in an instance where the data exchange pattern list comprises two or more data exchange patterns, the two or more data exchange patterns are determined by the AI-based analysis; and
receive, via a user device, the selected data exchange pattern from a user by transmitting the data exchange pattern list to the user with a request of selecting the selected data exchange pattern.

15. The computer program product of claim 14, wherein the one or more data exchange patterns in the data exchange list are based on (i) real-time data exchange rates and (ii) assessments associated with one or more data exchanges.

16. A computer-implemented method for an Artificial Intelligence (AI)-based real-time data exchange, the method being executed by one or more computing processor devices and comprising:
receiving a data exchange request, wherein the data exchange request is configured to request a data exchange from a base data type to an end data type, and includes a quantity of at least one of the base data type and the end data type;
identifying, using interactions through an Application Programming Interface (API) with a matching engine and data distribution networks, at least one data exchange pattern,
wherein, in an instance where one data exchange pattern is identified, the one data exchange pattern is (i) based on a direct data exchange between the base data type and the end data type and (ii) defined as a selected data exchange pattern, or
wherein, in an instance where two or more data exchange patterns are identified, determining the selected data exchange pattern from amongst the two or more data exchange patterns based on an AI-based analysis; and
executing the data exchange, utilizing the interactions through the API with the matching engine and the data distribution networks, using the selected data exchange pattern to exchange the data from the base data type to the end data type.

17. The computer-implemented method of claim 16, wherein the data exchange pattern is based on (i) real-time data exchange rates and (ii) assessments associated with one or more data exchange.

18. The computer-implemented method of claim 16, further comprising:
aggregating a plurality of data exchange requests; and
matching a first quantity of the aggregated plurality of data exchange requests to a second quantity of a counterpart data exchange requests within the data distribution networks.

19. The computer-implemented method of claim 16, wherein the base data type and the end data type are a same data type.

20. The computer-implemented method of claim 16, further comprising:
generating, using interactions through the API with the matching engine and the data distribution networks, a data exchange pattern list comprising one or more data exchange patterns,
wherein, in an instance the data exchange pattern list comprises one data exchange pattern, the data exchange pattern is based on the direct data exchange between the base data type and the end data type or
wherein, in an instance where the data exchange pattern list comprises two or more data exchange patterns, the two or more data exchange patterns are determined by the AI-based analysis; and
receiving, via a user device, the selected data exchange pattern from a user by transmitting the data exchange pattern list to the user with a request of selecting the selected data exchange pattern.
